(19) United States
(12) Patent Application Publication
(10) Pub. No.: US 2025/0284025 A1
(43) Pub. Date: Sep. 11, 2025

(54) GRAVITY SURVEYS ON AN UNSTAFFED AERIAL VEHICLE

(71) Applicant: Wisconsin Alumni Research Foundation, Madison, WI (US)

(72) Inventors: Sanket Sushil Deshpande, Madison, WI (US); Mikhail Kats, Madison, WI (US); Jennifer Choy, Madison, WI (US)

(21) Appl. No.: 18/596,069

(22) Filed: Mar. 5, 2024

(51) Int. Cl. G01V 7/16; G01V 7/06

(52) U.S. Cl. CPC G01V 7/16; G01V 7/06

(57) ABSTRACT

Systems and methods described integrate a strapdown gravity sensor such as a gravimeter on an unstaffed aerial vehicle to conduct gravity prospecting for identifying surface and subsurface features of interest.

### STATEMENT REGARDING FEDERALLY SPONSORED RESEARCH OR DEVELOPMENT

This invention was made with government support under 80NSSC23K0875 awarded by NASA and under 2016136 awarded by the National Science Foundation and under DE-AC02-06CH11357 awarded by the US Department of Energy. The government has certain rights in the invention.

### TECHNICAL FIELD

Embodiments relate generally to unstaffed or unmanned aerial vehicles (UAVs). More particularly, embodiments relate to gravity surveys using a gravity sensor on a UAV.

### BACKGROUND

Gravity surveys involve very accurate measurement of the acceleration experienced by a test mass due to Earth's gravitational potential. By comparing survey data with standard Earth gravity models, anomalies can be identified. These anomalies are caused by underground density and structural variations. Identifying such anomalies can lead to the discovery of valuable resources such as mineral ores, aquifers, tunnels, etc. Gravity surveys are therefore a powerful resource for underground exploration, where the density anomalies can lead to the discovery of structures and resources that cannot be identified by other remote sensing tools (such as imagery or radar).

For underground resource exploration, gravity surveys are currently conducted via one of three methods/platforms. In a first method, ground gravity surveys use gravity measurements taken by physically visiting each data point in the survey region with a gravimeter. However, because a trained professional must physically visit many points, such surveying is slow, expensive, and often impractical for large areas. Moreover, such surveying often requires exploration permits and surveyors often face difficulties in accessing private land. Additionally, most ground gravity survey instruments are relative gravimeters that need to be calibrated against an absolute gravity station periodically.

In a second method, airborne gravity surveys implement gravity measurements conducted by flying a gravimeter in an aircraft in a predetermined flight path over a survey region. However, airborne surveys require access to an airport, aircraft, and pilots. Moreover, the spatial resolution of airborne surveys is a function of the aircraft height, speed, and spacing between the survey lines. Since gravitational force is inversely proportional to the square of distance from the mass, it is desirable to conduct the survey at a lower height, which is often impossible or impractical for most aircrafts.

In a third method, airborne gravity gradiometry (AGG) surveys use a gradient of gravitational potential measured from a gravity gradiometer while flying in an aircraft/helicopter over the survey region. However, AGG instruments are covered under U.S. government International Traffic in Arms Regulations (ITAR), which makes it difficult to use them for conducting surveys in other countries, or across various countries. Moreover, conducting low-altitude, terrain-following flights requires specially trained aircraft and helicopter pilots, which makes the surveys further expensive and inaccessible.

Therefore, there is a demand for gravity survey systems and methods that can obtain high accuracy and spatial resolution gravity surveys over a large region in a fast, affordable, and accessible way.

### SUMMARY

Embodiments described or otherwise contemplated herein substantially meet the aforementioned needs of the industry. Systems and methods described or otherwise contemplated herein include integration of a strapdown gravity sensor such as a gravimeter on a multirotor, unstaffed aerial vehicle to conduct gravity prospecting for identifying surface and subsurface features of interest.

In an embodiment, geophysical surveys accurately measure gravity over a given area to identify anomalies in known Earth gravity models. Gravity anomalies can result from a previously unidentified underground mass density anomaly, such as mineral deposits, water aquifers, geologic hydrogen or tunnels. Embodiments therefore provide scalable, yet sustainable subsurface exploration surveys.

In a feature and advantage of embodiments, gravity surveys are conducted with better accuracy, are more cost effective, and are easier to implement than traditional surveys. Embodiments therefore improve geophysical survey applications requiring identification of subsurface features, such as mineral exploration, construction, and defense.

In an embodiment, a method of gravity prospecting with an unmanned aerial vehicle (UAV), comprises measuring total acceleration of a UAV during a gravity survey mission with a strapdown gravity sensor mounted to the UAV; receiving a global navigation satellite system (GNSS) satellite signal at the UAV; receiving a correction factor signal from a Real-time Kinematic (RTK)-GNSS base station at the UAV; obtaining kinematic acceleration of the UAV using the GNSS satellite signal and the correction factor signal; removing the kinematic acceleration of the UAV from the total acceleration of the UAV to obtain an effective gravitational acceleration; performing frequency filtering on the effective gravitational acceleration by applying a low pass filter to determine a low-frequency region of the effective gravitational acceleration; and determining a gravity anomaly based on the low-frequency region.

In an embodiment, a system for gravity prospecting, comprises an unmanned aerial vehicle (UAV) including: a processor and a memory operably coupled to the processor, a strapdown gravity sensor configured to measure total acceleration of the UAV during a gravity survey mission, and a GNSS transceiver configured to receive a global navigation satellite system (GNSS) satellite signal and a correction factor signal and determine a kinematic acceleration of the UAV using the GNSS satellite signal and the correction factor signal; and a gravity data processing engine configured to: remove the kinematic acceleration of the UAV from the total acceleration of the UAV to obtain an effective gravitational acceleration, perform frequency filtering on the effective gravitational acceleration by applying a low pass filter to determine a low-frequency region of the effective gravitational acceleration, and determine a gravity anomaly based on the low-frequency region.

In an embodiment, a method of gravity prospecting with an unmanned aerial vehicle (UAV), comprises measuring kinematic acceleration of the UAV using a global navigation satellite system (GNSS) satellite signal and a Real-time Kinematic (RTK)-GNSS base station correction factor signal; measuring gravitational acceleration in a body frame (b-frame) of the UAV with a gravity sensor; associating the kinematic acceleration with the gravitational acceleration; and isolating a gravity anomaly signal in the gravitational acceleration using the kinematic acceleration.

### BRIEF DESCRIPTION OF THE DRAWINGS

Subject matter hereof may be more completely understood in consideration of the following detailed description of various embodiments in connection with the accompanying figures, in which:

FIG. 1 is an illustration of navigation frame coordinate axes, according to an embodiment.

FIG. 2 is an illustration of a UAV with body frame (b-frame) coordinate axes, according to an embodiment.

FIG. 3 is a block diagram of system for gravity prospecting with a UAV, according to an embodiment.

FIG. 4 is a timing diagram of a system for gravity prospecting with a UAV using a GNSS satellite timing pulse, according to an embodiment.

FIGS. 5A-5B are a flowchart of a method of determining a gravity anomaly, according to an embodiment.

FIG. 6A is a graph of amplitude spectral density (ASD) of vibrational noise on a multi-rotor UAV, according to an embodiment.

FIG. 6B is an enlargement of the graph of FIG. 6A of ASD of vibrational noise on a multi-rotor UAV, according to an embodiment.

FIG. 7 is a graph illustrating cut-off frequency selection of a low-pass filter as a function of kinematic positioning accuracy of a UAV, according to an embodiment.

FIG. 8 is a diagram of a gravity anomaly produced by a sphere of density contrast including a corresponding graph of geologic and Fourier wavelengths, according to an embodiment.

FIG. 9 is a graph of threshold detection frequencies compared to the horizontal speed of a UAV, according to an embodiment.

FIG. 10 is a graph of threshold detection frequencies compared to the horizontal speed of a non-UAV aircraft.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Newton's Second Law of Motion in the presence of a gravitational field can be denoted in Equation 1.

$$m \ddot{x} = F + F g \qquad ( Equation 1 )$$

Here, \ddot{x} denotes the acceleration, F denotes all the applied forces on the test mass m excluding Fg with is the force associated with gravitational attraction. Using Newton's Law of Gravitation Fg, can be derived as Equation 2.

$${F}_{g} = G \frac{Mm}{{\vert l \vert}^{2}} \frac{l}{\vert l \vert} \qquad ( Equation 2 )$$

In Equation 2, G is Newton's gravitational constant, M is the attracting mass and l denotes the vector originating at the test mass and going to the attracting mass. An inertial frame of reference (i-frame) is a frame in which an object with net zero force acting on it will be perceived to be in motion with a constant velocity. In other words, the inertial frame of reference is a frame of reference not undergoing any acceleration. For example, the inertial frame of reference can be an Earth-centered frame of reference. For simplicity of explanation, a non-rotating Earth is assumed henceforth. Moreover, a plumb line is defined as a line that corresponds to the direction of gravity at a point near the Earth's surface such that an object will fall along the plumb line when dropped with zero velocity. Accordingly, in an inertial frame, Equation 1 can be rewritten as Equation 3.

$${\ddot{x}}^{i} = {a}^{i} + {g}^{i} \qquad ( Equation 3 )$$

$$where a = \frac{F}{m}$$

denotes the acceleration resulting from the applied forces F. A gravimeter in an Earth centered (inertial) frame in a static condition can include relative (spring) gravimeters (contrasted with absolute gravimeters in which a test mass is tracked in a vacuum), a test mass attached to a spring is used to measure the acceleration. In static condition, the test mass and the spring experience no acceleration, hence \ddot{x}=0. Therefore, using Equation 3, a=−g. If the sensitive axis is along the plumb line, then a is the acceleration due to the reaction force of the Earth that is preventing the gravimeter from falling. For scalar airborne gravimetry, the gravitational acceleration g is derived from Equation 3 as Equation 4.

$${g}^{i} = {\ddot{x}}^{i} - {a}^{i} \qquad ( Equation 4 )$$

where the position x is determined from a tracking system such as GPS/GNSS and differentiating to obtain \ddot{x}ⁱ, and aⁱ is obtained from the gravimeter.

Generally, gravity is not measured in the inertial frame, but instead in the navigation frame (n-frame). The navigation frame is also referred to as the north-east-down (NED) frame, after its bases in the cartesian system.

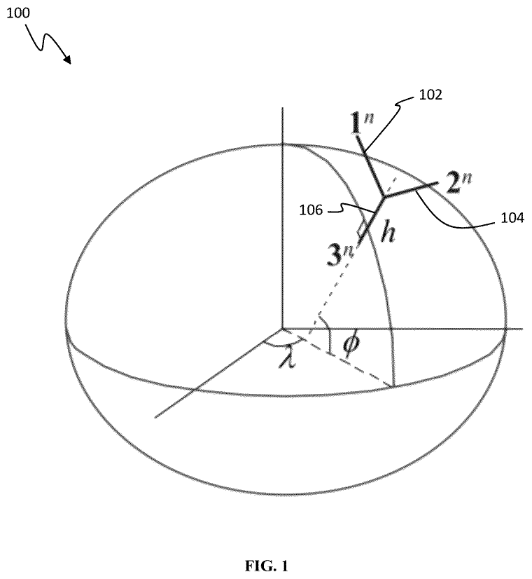

Referring to FIG. 1, an illustration of a navigation frame 100 is depicted, according to an embodiment. Navigation frame 100 moves with the vehicle/platform but is not used to denote the coordinates of the vehicle. Instead, navigation frame 100 is used as the reference frame for the velocity and orientation of the vehicle, and most importantly, for measuring gravity. As illustrated, navigation frame 100 axes are defined as North 102 (1ⁿ), East 104 (2ⁿ) and Down 106 (3ⁿ).

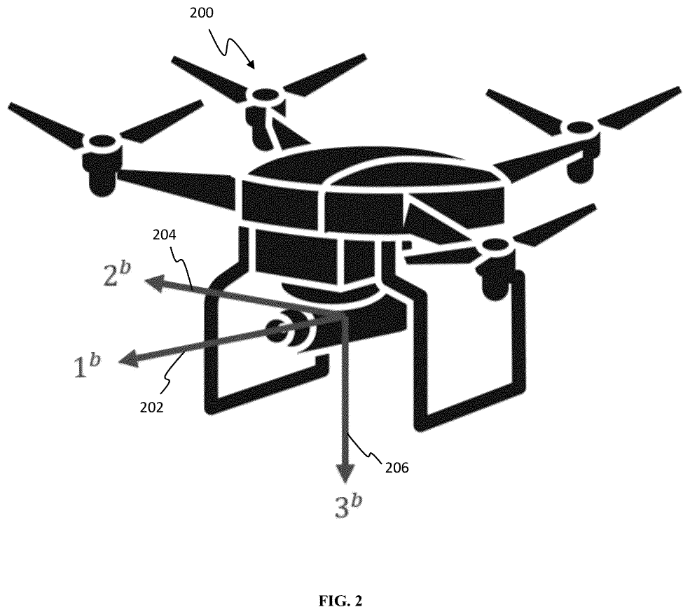

Embodiments utilize another frame of reference, the body frame or b-frame. The b-frame of reference is attached to the body of the vehicle, such as a UAV. Referring to FIG. 2, an illustration of a UAV 200 with body frame (b-frame) coordinate axes is depicted, according to an embodiment. Body frame axes are defined as Forward 202 (1^{b}), to-the-Right 204 (2^{b}) and through-the-Floor 206 (3^{b}).

Embodiments implement strapdown configuration gravity sensors mounted on a UAV in a body frame. A gravity sensor (e.g. gravimeter) is mounted in the b-frame, such that it changes its orientation along with the vehicle. This requires accurate measurement of the gravimeter's orientation using gyroscopes, so that the acceleration measured in the b-frame (ab) can be transformed to acceleration in the n-frame (an). The gravitational acceleration vector measured in the n-frame is determined by Equation 5.

$${g}^{n} = {C}_{i}^{n} ( {\ddot{x}}^{i} - {C}_{b}^{i} {a}^{b} ) \qquad ( Equation 5 )$$

where
gⁿ: gravitational acceleration in the n-frame,
Cᵢⁿ: known coordinate transformation matrix from i-frame to n-frame,
\ddot{x}ⁱ: double-differentiation of the position of the vehicle xi in the i-frame. This is also referred to as the kinematic acceleration,
C_{b}ⁱ: transformation from b-frame to i-frame using tilt measurements from the gyroscopes, and
a^{b}: acceleration in the b-frame measured by the gravimeter.

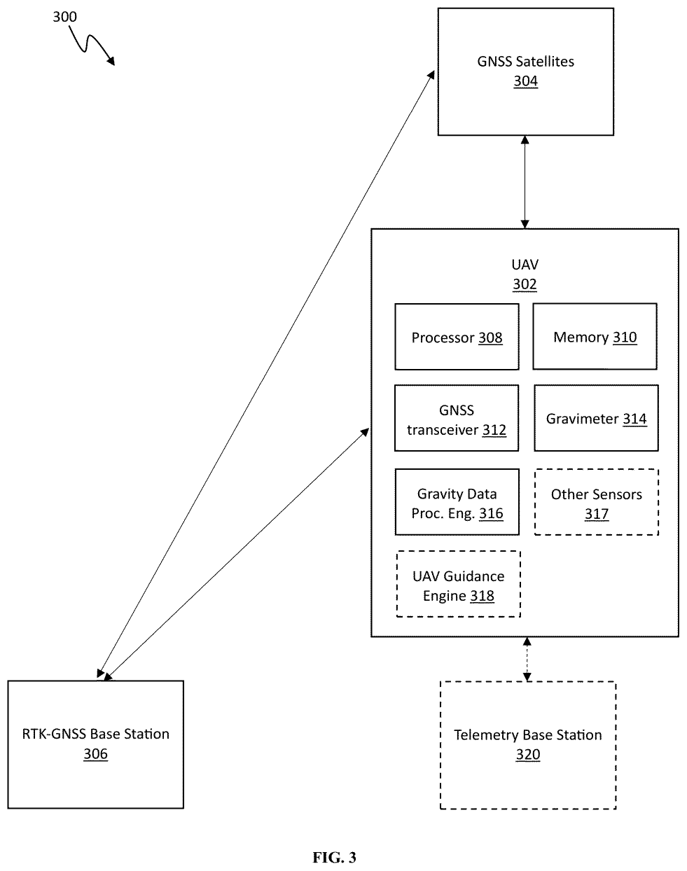

Referring to FIG. 3, a block diagram of system 300 for gravity prospecting with a UAV is depicted, according to an embodiment. System 300 generally comprises a UAV 302, global navigation satellite system (GNSS) satellites 304, and a Real-Time Kinematic (RTK)-GNSS base station 306. In an embodiment, system 300 can be utilized to conduct one or more gravity surveys or gravity prospecting at or below a ground surface. For example, a ground surface can include a surface of the Earth, a surface of another planet such as Mars, or a surface of the moon.

Embodiments described herein include various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

UAV 302 is a powered, aerial vehicle that uses aerodynamic forces to provide vehicle lift. In embodiments, UAV 302 does not carry a human operator, but rather, UAV 302 can fly autonomously or be piloted remotely. In an embodiment, UAV 302 comprises a drone. In an embodiment, UAV 302 comprises a multi-rotor drone. For example, UAV 302 can conduct vertical takeoff and landing (VTOL). In an embodiment, UAV 302 is powered by a gasoline or an electric motor. In another embodiment, UAV 302 is powered by an ionic propulsion system that forces ions through pairs of electrodes to propel the UAV.

In an embodiment, UAV 302 can switch modes between multi-rotor and fixed wing configurations. For example, a drone capable of both fixed wing and multi-rotor flight can fly relatively fast (e.g. compared to rotor flight) in a fixed wing configuration to the survey region, conduct the survey in multi-rotor configuration relatively slow (e.g. compared to fixed wing flight) and then fly back in fixed wing. In another example, a drone capable of both fixed wing and multi-rotor flight can conduct a low-resolution survey in a fixed wing configuration (since the drone is moving fast) and conduct a high-resolution survey in a multi-rotor configuration, while the drone is moving more slowly. In another embodiment, UAV 302 can comprise an airship or balloon that is lifted using aerostatics.

In an embodiment, UAV 302 weighs at least 0.2 kg, in some aspects at least 0.5 kg, in some aspects at least 1 kg, in some aspects at least 5 kg, in some aspects at least 10 kg, in some aspects at least 20 kg, in some aspects at least 30 kg, in some aspects at least 40 kg. In some aspects, UAV 302 weighs up to 100 kg, in some aspects up to 90 kg, in some aspects up to 80 kg, in some aspects up to 70 kg, in some aspects up to 60 kg, and in some aspects up to 50 kg.

In embodiments, UAV 302 can carry a payload such as a gravity sensor (e.g. gravimeter 314, as will be discussed). UAV 302 can carry a payload having a payload weight. In some aspects the payload weight is at least 10 g, in some aspects at least 100 g, in some aspects at least 500 g, in some aspects at least 1 kg, in some aspects at least 10 kg, and in some aspects at least at least 20 kg. For example, the gravimeter can be a micro-electromechanical system (MEMS) gravimeter and weigh as little as 10 grams. In some aspects the payload weight is up to 100 kg, in some aspects up to 90 kg, in some aspects up to 80 kg, in some aspects up to 70 kg, in some aspects up to 60 kg, in some aspects up to 50 kg, in some aspects up to 40 kg, and in some aspects up to 30 kg. For example, the gravimeter can be spring-mass gravimeter or a cold-atom gravimeter weighing up to 100 kg.

In an embodiment, the weight of the UAV itself is directly proportional to the weight of the payload itself. A heavier payload requires a larger propellor surface area, higher torque on motors (achieved by increasing the number of coil windings), etc, thus requiring a heavier UAV. In one particular embodiment, to carry a 10 gram MEMS gravimeter, a 200 gram UAV can be used, whereas for heavier payloads, a drone as heavy as 100 kg can be used.

In embodiments, UAV 302 can carry a payload of a gravity sensor. In other embodiments, UAV 302 can carry a payload of a gravity sensor along with ancillary geophysical survey instruments such as a magnetometer or a hyperspectral camera (e.g. other sensors 317). UAV 302 can carry payloads up to 15″×17″×34″ in dimension. In an embodiment with respect to cubesat dimensions, UAV 302 can carry payloads up to 12 U or larger.

In an embodiment, during gravity prospecting/survey, in some aspects UAV 302 can travel with speed of 0.0 m/s (for example, when the UAV hovers over an area without moving), in some aspects at least 0.02 m/s, in some aspects at least 0.05 m/s, in some aspects at least 0.1 m/s, in some aspects at least 5 m/s, in some aspects at least 10 m/s, in some aspects at least 20 m/s. In some aspects UAV 302 can travel with speed up to 60 m/s, in some aspects up to 50 m/s, in some aspects up to 40 m/s, and in some aspects up to 30 m/s. In an embodiment, during gravity prospecting/survey, UAV 302 can travel with speed ranging between 0 m/s and 60 m/s, in some aspects between 0.02 m/s and 50 m/s, in some aspects between 1.0 m/s and 40 m/s, in some aspects between 1.5 m/s and 30 m/s, and in some aspects between 2.5 m/s and 13 m/s.

In an embodiment, during a generally “low” elevation gravity prospecting/survey, UAV 302 can fly at an elevation of at least 0.05 m above ground, in some aspects at least 0.1 m above ground, in some aspects at least 2 m above ground, in some aspects at least 3 m above ground, in some aspects at least 5 m above ground, in some aspects at least 10 m above ground, in some aspects at least 20 m above ground, and some aspects at least 30 m above ground. In some aspects, UAV 302 can fly at an elevation of up to 80 m above ground, in some aspects up to 70 m above ground, in some aspects up to 60 m above ground, in some aspects up to 50 m above ground, and in some aspects up to 40 m above ground.

In an embodiment, during a low elevation gravity prospecting/survey, UAV 302 can fly at an elevation between 0.05 m and 80 m above ground level. In some aspects, UAV can fly at an elevation between 0.05 m and 50 m, in some aspects between 0.05 and 25 m, in some aspects between 0.05 and 10 m, in some aspects between 0.05 and 3 m, and in some aspects between 0.05 and 2 m.

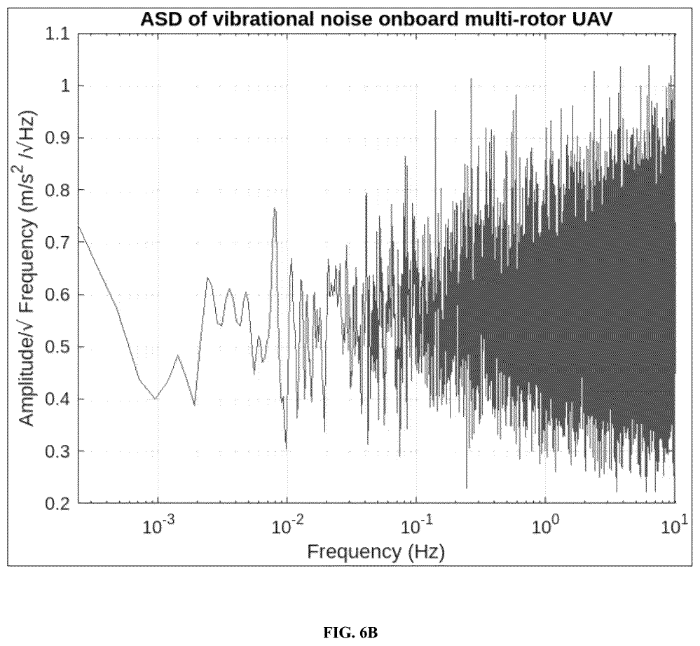

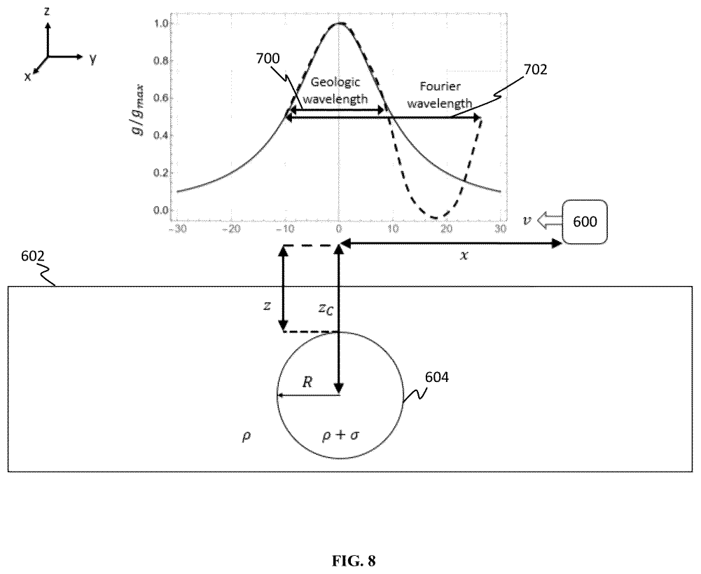

In an example embodiment of a low elevation survey, a UAV flying at 2 m height above the ground level carries a gravimeter and has an RTK-GNSS position accuracy of 2 cm, and a cut-off frequency for its low-pass filter of 5 mHz or 0.005 Hz (see FIG. 7). With such a cutoff frequency, the UAV can be flown to identify chalcopyrite deposits buried 50 to 500 m below the ground with speed between 2.5-12.5 m/s (see FIG. 9). These correspond to chalcopyrite spherical deposits with radius ranging from 106 m to 318 m.

In some aspects, UAV 302 can fly at an elevation of at least 80 m above ground, in some aspects at least 90 m above ground, in some aspects at least 100 m above ground, in some aspects, at least 150 m above ground. In some aspects, UAV 302 can fly at an elevation of up to 300 m above ground, in some aspects up to 250 m above ground, and in some aspects up to 200 m above ground.

In an embodiment, during a generally “high” elevation gravity prospecting/survey, UAV 302 can fly at an elevation between 80 m and 300 m. In some aspects, UAV can fly at an elevation between 80 m and 250 m, in some aspects between 80 m and 200 m, in some aspects between 80 m and 150 m.

In an example embodiment of a high elevation survey, a UAV flying at 300 m height above the ground level carries a gravimeter and has an RTK-GNSS position accuracy of 2 cm, and a cut-off frequency for its low-pass filter of 5 mHz or 0.005 Hz (see FIG. 7). With such a cutoff frequency, the UAV can be flown to identify chalcopyrite deposits buried 400 to 800 m below the ground with speed between 15-25 m/s (which is not possible with fixed wing aircraft). These correspond to chalcopyrite spherical deposits with radius ranging from 382 m to 495 m.

The aforementioned examples provide at least two exemplary operational modes. In a first “high elevation” operational mode, looking for larger features is done better with a high-altitude UAV flying with faster speeds (yet slower than fixed wing aircraft) (e.g. UAV altitude/elevation: 80 m-300 m; UAV speed: 13 m/s-60 m/s. In a second “low elevation” operational mode, looking for smaller features is done better with a low-altitude UAV flying slower (e.g. UAV altitude/elevation: 0.05 m-80 m; UAV speed: 0.02 m/s-13 m/s.) In an embodiment, during gravity prospecting/survey, UAV 302 can maintain a constant elevation above the terrain (drape flying). In other embodiments, during gravity prospecting/survey, UAV 302 can fly above the terrain with variable elevation.

UAV 302 generally comprises a processor 308, a memory 310, a GNSS transceiver 312, a gravimeter 314, and a gravity data processing engine 316. Optionally, in an embodiment, UAV 302 further comprises other sensors 317. Optionally, in an embodiment, UAV 302 further comprises a UAV guidance engine 318.

Processor 308 can be a programmable device that accepts digital and/or analog data as input, is configured to process the input according to instructions or algorithms and provides results as outputs. In an embodiment, processor 308 can be a central processing unit (CPU) configured to carry out the instructions of a computer program.

Memory 310 can comprise volatile or non-volatile memory as required by the coupled processor 308 to not only provide space to execute the instructions or algorithms, but to provide the space to store the instructions themselves. In embodiments, memory 310 can further comprise storage for data related to system 300, such as gravity sensor data and/or GNSS data. In an embodiment, processor 308 can utilize instructions stored in memory 310, that when executed by processor 308, cause processor 308 to implement the engines of UAV 302 or algorithms associated with components of UAV 302.

GNSS transceiver 312 comprises an electronic device including a transmitter component and a receiver component for communication of GNSS data. GNSS transceiver 312 is configured to communicate with GNSS satellites 304, for example, over one or more wireless communication channels. In an embodiment, GNSS transceiver 312 is configured to receive data related to positioning and timing from a satellite or multiple satellites (e.g. GNSS satellites 304, as will be explained). In an embodiment, GNSS transceiver 312 is configured to transmit data to a satellite or multiple satellites, such as an ACK signal to indicate successful reception (e.g. upon successful execution of a GNSS transceiver 312 command).

Gravimeter 314 comprises one or more measuring instruments of gravitational field of the Earth at specific location. Though “gravimeter” is depicted in FIG. 3 for ease of discussion, gravimeter 314 can include any gravity sensing device or a plurality of sensing devices. In embodiments, gravimeter 314 can comprise a spring-mass system or MEMS including accelerometers and gyroscopes. In other embodiments, gravimeter 314 can be quantum in nature, utilizing technologies such as cold-atom interferometry, or nitrogen vacancy centers in diamonds.

In other embodiments, gravimeter 314 can comprise a gravity gradiometer. In other embodiments, gravimeter 314 can comprise two or more gravimeters. In general, gravimeter 314 can provide total acceleration of UAV 302.

In an embodiment, gravimeter 314 can be sensitive in only one Cartesian axis. In another embodiment, gravimeter 314 can be sensitive in multiple Cartesian axes.

In an embodiment, gravimeter 314 has an accuracy of at least 10 μGal, in some aspects at least 100 μGal, in some aspects at least 500 μGal, in some aspects at least 1 mGal, and some preferred embodiments at least 2 mGal. In some aspects, gravimeter 314 has an accuracy of up to 50 mGal, in some aspects up to 40 mGal, in some aspects up to 30 mGal, in some aspects up to 20 mGal, and in some aspects up to 10 mGal.

In contrast to platform-stabilized or gimbal configuration gravity sensors, which rely on mounting the gravimeter/AGG on a stabilization platform which is then mounted on the vehicle body, such that the platform has gyroscopes, a computer, and motors that constantly ensure that the gravimeter/AGG is oriented in the n-frame, gravimeter 314 is not platform-stabilized and is mounted in the b-frame (as illustrated in FIG. 2).

Moreover, compared to platform-stabilized or gimbal configuration gravity sensors, a strapdown airborne gravimeter such as gravimeter 314 is lighter, compact, has lower power consumption, lower fail rate (due to fewer moving parts) and provides increased operational flexibility. For example, in an embodiment of UAV 302 having a limited payload capacity (e.g. 30 kgs), gravimeter 314 comprises a weight of half or less than half of the payload capacity, or 15 kg or less. For example, gravimeter 314 can weigh ˜8 kgs with compact dimensions ˜187×130×330 mm3. In other embodiments, gravimeter 314 can comprise a weight of more than half of the payload capacity of UAV 302.

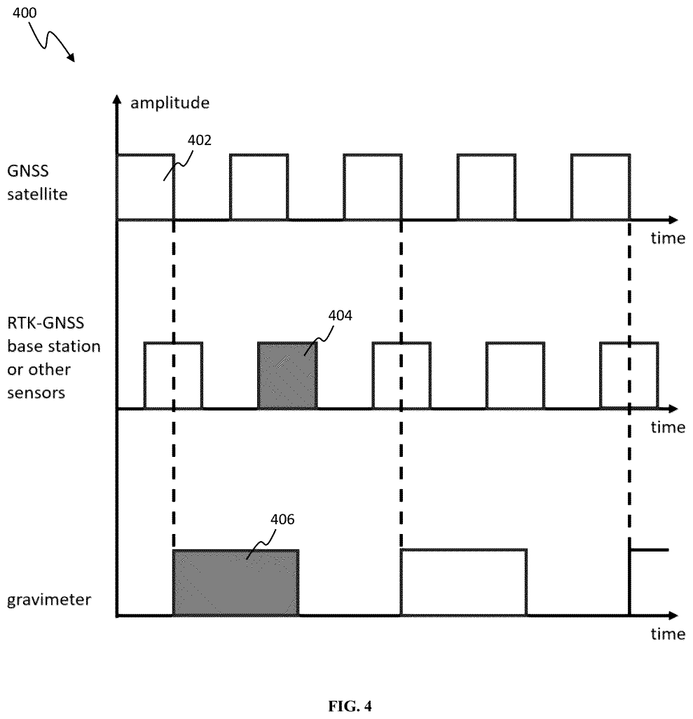

Gravity data processing engine 316 is configured to receive and process gravity data sensed by gravimeter 314 as tracked by GNSS data. In one embodiment, gravity data processing engine 316 is configured to receive the gravity data from gravimeter 314 and/or GNSS transceiver 312 and process the gravity data in real-time. Such processing can include operations that will be described further with respect to FIG. 4. In another embodiment, gravity data processing engine 316 is configured to receive the gravity data from gravimeter 314 and/or GNSS transceiver 312 and store the gravity data in memory 310. In such embodiments, gravity data can be processed asynchronously or later in time, such as when UAV 302 lands. Gravity data processing engine 316 can coordinate with other components of system 300, such as telemetry base station 320, to process the gravity data.

As mentioned above, in an embodiment, UAV 302 further comprises other sensors 317. For example, UAV 302 can include Light Detection and Ranging (LIDAR) sensors, a magnetometer, a camera, a geophysical survey instrument, or other sensor used for navigation of UAV 302 or surveying by UAV 302.

As also mentioned above, in an embodiment, system 300 optionally further comprises a telemetry base station 320. Telemetry base station 320 can comprise a fixed or movable base station that is communicatively coupled to UAV 302. In an embodiment, telemetry base station 320 can comprise an antenna and a computing device for receiving, storing, and processing gravity data. For example, some or all of the gravity data can be processed by gravity data processing engine 316. In another example, gravity data processing engine 316 can communicate gravity data to telemetry base station 320, which can process all of the gravity data using its own telemetry base station gravity data processing engine. In an embodiment, telemetry base station 320 can be used to program the flight path of UAV 302.

UAV guidance engine 318 is configured to control the flight path of UAV 302. In one embodiment, UAV guidance engine 318 is configured to receive real-time control instructions for flight over an area of interest from an operator located on the ground. In another embodiment, UAV guidance engine 318 is configured to automatically control UAV 302 for flight over an area of interest. For example, UAV guidance engine 318 can be pre-programmed by an operator or via a base station. In particular, UAV guidance engine 318 can be programmed on a ground base station to execute a certain gravity survey mission, such that UAV 302 executes the gravity survey mission and returns to its base. In other embodiments, UAV guidance engine 318 can be programmed such that such that UAV 302 executes multiple gravity survey missions and returns to its base. In other embodiments, UAV guidance engine 318 can be programmed such that UAV 302 carries out a portion of a survey on an area of interest, returns to base, recharges, then returns to the area of interest to complete the survey. In still other embodiments, UAV guidance engine 318 can be programmed such that UAV 302 travels to an area of interest, returns for charging, then returns to the area of interest for surveying, then returns for charging, then returns to the area of interest for surveying such that the iterations of travel to the area of interest and charging can be executed multiple times to complete the survey.

GNSS satellite 304s generally includes three or more satellites providing signals from space that transmit positioning and timing data to GNSS receivers (e.g. GNSS transceiver 312). Effectively, GNSS satellites 304 transmits signals that report where GNSS satellites 304 is at what time, with that information being used to determine position of UAV 302 as a function of time, which is then twice-differentiated to calculate kinematic acceleration.

In an embodiment, real-time kinematic GPS uses a combination of GPS signals and a local base station to provide highly accurate positioning data. In particular, by using a local base station in addition to satellite signals, embodiments can correct for any errors that may be present in the GPS data. This is achieved by comparing the GPS data received by the base station and the GPS data received by the mobile unit. Any errors that are present in the data are then corrected, resulting in highly accurate positioning data.

RTK-GNSS base station 306 is therefore generally positioned in a fixed, known location and includes a GNSS receiver that acquires GNSS location data from GNSS satellite 304. GNSS base station 306 generally comprises of a receiver antenna, a GNSS receiver, and a device to which the GNSS data is logged and processed (e.g. a computer). RTK-GNSS base station 306 calculates the error between the location determined by GNSS and its actual known locations. Then, RTK-GNSS base station 306 transmits the correction factors via a transmitter antenna. These correction factors are received by any RTK-GNSS compatible receiver device (e.g. GNSS transceiver 312) within the transmitter antenna's range. The errors can occur due to several factors such as atmospheric disturbances, satellite orbit errors or clock errors. The correction factors inform the receiver RTK-GNSS device on correcting its GNSS-determined position. Accordingly, in embodiments, the position of UAV 302 can be determined with a relatively high accuracy using real-time-kinematics GNSS via GNSS base station 306 and GNSS satellites 304 in coordination with GNSS transceiver 312 compared to traditional solutions. In an embodiment, GNSS data is associated with gravity data. In one embodiment the GPS timing signal can be used for synchronization of the gravimeter. In another embodiment, GNSS data is aligned with gravity data when GNSS is not used for synchronization of the gravimeter. In both embodiments, the time stamp from the GNSS is utilized to identify the position and the corresponding gravitational acceleration measurement. The GNSS-based time synchronization may or may not be used to coordinate various tasks/measurements onboard the UAV. The embodiment described below demonstrates an example of how the GNSS timing signal can be utilized for synchronization.

In another embodiment, the GPS timing signal is used for synchronization of the gravimeter and/or other onboard sensors/instruments or the GNSS base station. For example, in system 300, GNSS transceiver 312 can be communicatively coupled with gravimeter 314 (and optionally other sensors 317). Referring further to FIG. 4, a timing diagram 400 FIG. 4 of a system for gravity prospecting with a UAV using a GNSS satellite timing pulse is depicted, according to an embodiment. Timing diagram 400 illustrates the signals of a GNSS satellite, a GNSS base station or other sensor, and a gravimeter for time along the X-axis and amplitude along the Y-axis.

In the example depicted, the GNSS antenna (e.g. GNSS transceiver 312) receives a periodic signal 402 (1 Hz or 10 Hz, in embodiments) from a GNSS satellite (e.g. GNSS satellites 304). The falling edge of periodic signal 402 is used to trigger the gravimeter measurement at 406. In this way, the gravimeter is transformed into a GPS-referenced gravimeter. In an embodiment, the gravimeter measurement may or may not last longer than the time period of the GNSS satellite signal.

In general, synchronization is carried out by processor 308, wherein the falling edge of the GNSS satellite signal acts a trigger for processor 308 to begin collecting data, including from gravimeter 314, RTK-GNSS base station 306, and/or any other sensors 317. In the scenario where the gravimeter measurement time is longer than the time period of the GNSS satellite signal, processor 308 waits until gravimeter 314 (and any other sensor 317) data acquisition is complete, and the data is received, processed, stored or transmitted (as desired during the UAV 302 operation). The next available falling edge from the GNSS signal will trigger the next data collection operation by processor 308.

Other instruments producing periodic signals, such as the GNSS base station, can be synchronized by choosing the next available data pulse 404. For example, the first GNSS satellite falling edge (e.g. from signal 402) triggers the gravimeter measurement 406. This gravimeter measurement is binned together with the second RTK-GNSS base station data, highlighted in FIG. 4 as 404.

While some sensors and/or instruments interfaced with processor 308 await instructions from processor 308 to begin transmitting the data, some sensors keep transmitting the data to processor 308 in a periodic manner. In the example illustrated in FIG. 4, gravimeter 314 is shown to await instructions from processor 308, while the signal from RTK-GNSS base station 306 is periodic, but has a time offset. The falling edge from the GNSS satellite signal 402 triggers the measurement cycle of gravimeter 406. But, the falling edge of the GNSS satellite pulse 402 arrives midway between the RTK-GNSS data pulse. Hence, the next available pulse from the RTK-GNSS 404 is used to read its measurement and is synchronized with the gravimeter 406 measurement.

In operation, referring again to FIG. 3, UAV 302 is configured to fly over a region of interest for gravity surveying (such as by manual control or automated control using UAV guidance engine 318). During flight, UAV 302 is communicatively coupled to GNSS satellites 304 such that GNSS transceiver 312 receives communications from GNSS satellites 304. In an embodiment, UAV 302 is communicatively coupled to RTK-GNSS base station 306 such that GNSS transceiver 312 and/or gravimeter 314 receives communications from RTK-GNSS base station 306. During flight, UAV 302 gravimeter 314 takes a plurality of gravity measurements over the region of interest.

In certain embodiments, the operation of UAV 302 can be modified based on actual data collected. For example, in an embodiment in which UAV 302 and/or telemetry base station 320 can conduct real-time evaluation of the data collected during a survey, depending on the quality of collected data, UAV 302 can be recalled to the base station (for example, if the data collected does not make sense in the context of known gravity information in the area, and the instrument requires maintenance), or change the flight trajectory or altitude to improve the quality of data.

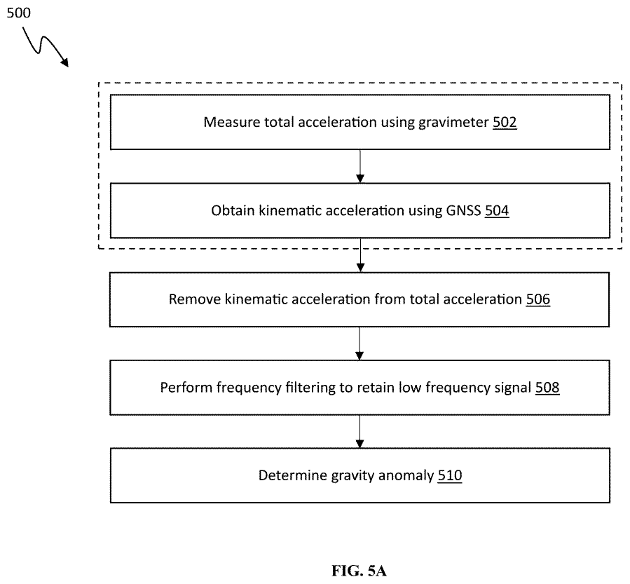

Referring to FIGS. 5A-5B, a flowchart of a method 500 of determining a gravity anomaly is depicted, according to an embodiment. In an embodiment, method 500 can be implemented by system 300 including with a UAV 302 having a strapdown gravimeter 314.

Referring first to FIG. 5A, at 502, a gravimeter measures acceleration. For example, strapdown gravimeter 314 can be used to measure total acceleration of UAV 302 during flight. For example, gravimeter measurement (a) can be a single measurement or an average of N measurements conducted during a time period to correspond to a “single” measurement of kinematic acceleration (\ddot{x}). In embodiments, N measurements of (a) in the same time period as a single measurement of (\ddot{x}), the sampling frequency of (a) needs to be higher than that of (\ddot{x}) by a factor of at least 1/N. In an embodiment, gravity data processing engine 316 processes gravimeter 314 data to determine total acceleration measured by gravimeter 314.

At 504, kinematic acceleration is obtained using GNSS. In an embodiment, total acceleration (a) at 502 and kinematic acceleration (\ddot{x}) are measured simultaneously, as indicated by the dashed line around 502 and 504 in FIG. 5A.

Referring further to FIG. 5B, the sub-operation of obtaining kinematic acceleration at 504 is further depicted. In particular, RTK-GNSS base station 306 is placed at a known location. At 550, RTK-GNSS base station 306 acquires the GNSS location from GNSS satellites 304, and then measures the error between the known position coordinates and the GNSS-derived position coordinates. RTK-GNSS base station 306 then calculates the correction factor used to match the known position coordinates and the GNSS-derived position coordinates and transmits the correction factors to UAV 302. At 552, GNSS transceiver 312 receives the correction factors transmitted by RTK-GNSS base station 306. At 554, GNSS transceiver 312 determines its GNSS-derived location by using the received correction factors to correct the GNSS-derived kinematic position. At 556, the GNSS-derived kinematic position is double-differentiated to determine the kinematic acceleration.

Referring again to FIG. 5A, at 506, the kinematic acceleration is removed from total acceleration. For example, gravity data processing engine 316 (in coordination with telemetry base station 320, in some embodiments) can effectively “subtract” the kinematic acceleration from the total acceleration. An “effective gravitational acceleration” results from the subtraction of kinematic acceleration from total acceleration.

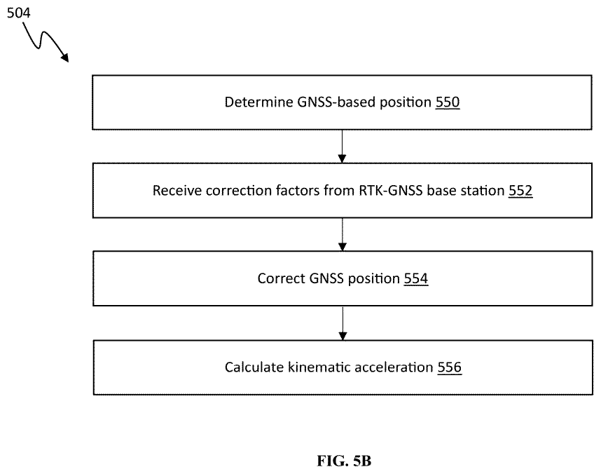

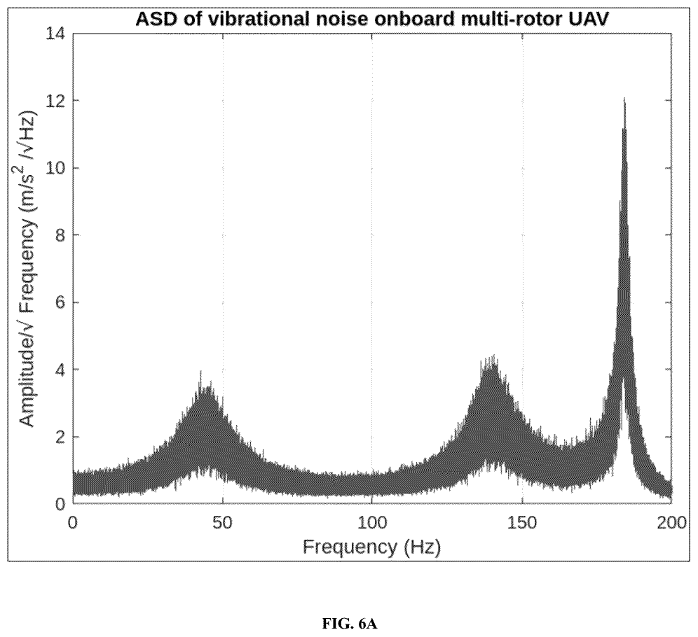

At 508, frequency filtering is conducted on the remaining effective gravitational acceleration to retain a low frequency signal. For example, gravity data processing engine 316 (in coordination with telemetry base station 320, in some embodiments) can remove noise from the gravimetry signal such as the effective gravitational acceleration. This is described further with respect to FIGS. 6A and 6B.

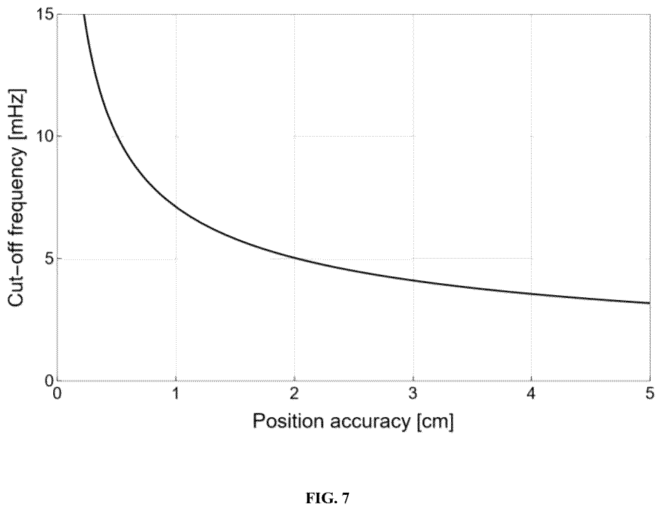

At 510, a gravity anomaly is determined. For example, gravity data processing engine 316 (in coordination with telemetry base station 320, in some embodiments) can determine a gravity anomaly based on the low frequency signal. Anomaly detection is described further with respect to FIG. 8.

As described herein, a gravimeter or other gravity sensing device measures total acceleration, and gravity surveys are generally interested in only measuring the acceleration along the 3ⁿ axis (see FIG. 1), which is along the gravitational acceleration of the Earth. The acceleration measured therefore includes the signal (gravity anomalies the survey aims to identify) and noise (primarily due to motion of the vehicle). Therefore, the primary challenge behind airborne gravimetry (or any kind of moving base gravimetry) is isolating the gravity anomaly (signal) from the accelerations of the vehicle. For simplicity, assume that the gravitational acceleration is in the perfectly vertical direction, i.e. along the 3ⁿ axis. Hence, the primary concern is with the motion of the vehicle in the vertical direction. To be able to isolate the accelerations caused by this motion, it is important to be able to measure such accelerations.

UAV motion is tracked using the GNSS signal and its kinematic accelerations are calculated by deriving its kinematic position using GNSS. Kinematic acceleration is represented by the \ddot{x}ⁱ component in Equation 5. The Earth's gravity gradient is approximately 0.3086 mGal/m. Thus, obtaining good position accuracy in the vertical direction is important. In certain embodiments, in some aspects using real-time kinematic positioning (RTK), a GNSS position accuracy of at least 5 cm can be determined, in some aspects an accuracy of at least 4 cm can be determined, in some aspects an accuracy of at least 3 cm can be determined, in some aspects an accuracy of at least 2 cm can be determined, and in some aspects an accuracy of at least 1 cm can be determined. In embodiments, a gravimeter can have an RTK-GNSS accuracy of 2 cm, which translates to a negligible positioning-based error of 0.0067 mGal.

The signal produced by the gravity anomalies of interest (e.g. for geophysical exploration) is several tens of milligals in magnitude. However, measured vertical accelerations by the gravimeter (the a^{b} component in Equation 5) is in the several 10,000 mGal magnitude, due to the accelerations of the UAV. But, the gravity anomaly signal is usually in the low-frequency region (<0.001 Hz), whereas the vehicle noise comprises the high frequency component of the spectrum.

For example, referring to FIG. 6A, a graph of amplitude spectral density (ASD) of vibrational noise on a multi-rotor UAV is depicted, according to an embodiment. FIG. 6A illustrates that most of the vibrational noise experienced by UAVs is in the high frequency (>10 Hz) domain. This ADS illustration is depicted for example only, as the vibration profile will vary based on the engine(s), windflow and aerodynamics of the specific UAV.

Referring further to FIG. 6B, an enlargement of the graph of FIG. 6A is depicted, according to an embodiment. As illustrated, FIG. 6B covers the DC-10 Hz frequency range. Embodiments of gravity surveys described herein therefore focus on observing signal in the low-frequency region (<1 Hz) and employ low-pass filters of ˜50 s (0.02 Hz) or longer (shorter frequency).

Accordingly, the acceleration measurement from the gravimeter (e.g. 502) undergoes subtraction (e.g. 506) of the UAV's kinematic accelerations (e.g. 504) as in Equation 5 followed by frequency filtering (e.g. 508) wherein only the low frequency signal is retained. This process helps remove the noise from the gravimetry signal to determine a gravity anomaly (e.g. 510).

After removing bias in a leveled-flight condition, inaccuracy in position determination is one cause of error in gravity measurements using an UAV. Error in kinematic position determination translates to the error in determining kinematic acceleration, as shown in Equations 6 through 8. This error then propagates in determining the gravitational acceleration ‘g’ in Equation 4.

A sinusoidal error δs of amplitude A and frequency ω in determining the kinematic position of the gravimeter can be defined by Equation 6.

$$δ s = A cos ω t \qquad ( Equation 6 )$$

This error propagates to the kinematic acceleration error as Equations 7 and 8.

$$δ \ddot{x} = - A {ω}^{2} cos ω t \qquad ( Equation 7 )$$

$$\vert δ \ddot{x} \vert = A {ω}^{2} \qquad ( Equation 8 )$$

Considering an accuracy requirement 2 mGal from the UAV gravimeter, and a cut-off frequency for the low pass filter to be

$${ω}_{c} = 2 π \times 0.005 Hz ( \frac{1}{{f}_{c}} = 200 s ) ,$$

the maximum allowable error in determining the position is defined by Equations 9 and 10.

$$2 \times {10}^{- 5} = {{A}_{max} ( 2 π \times 5 \times {10}^{- 3} )}^{2} \qquad ( Equation 9 )$$

$$A max = 2 cm \qquad ( Equation 10 )$$

Therefore to achieve an accuracy of 2 mGal with the UAV gravimeter, a maximum allowable error in determining the kinematic position of the gravimeter is 2 cm or 0.02 m. This error fits within the positioning accuracy of 2 cm (or better) possible with RTK-GNSS systems.

When better positioning accuracy is available, a higher cutoff frequency can be selected. Therefore, the selection of the low-pass filter is contingent on the positioning accuracy available for calculating the kinematic accelerations. Using Equation 8, the low-pass filter cut-off frequency can be written as Equation 11.

$${f}_{c} = ( \frac{1}{2 π} ) \sqrt{\frac{\vert δ \ddot{x} \vert}{{A}_{max}}} \qquad ( Equation 11 )$$

For example, referring to FIG. 7, a graph illustrating cut-off frequency selection of a low-pass filter as a function of kinematic positioning accuracy of a UAV is depicted, according to an embodiment. In particular, the relationship between the cutoff frequency f_{c} and Aₘₐₓ for a given kinematic acceleration accuracy |δ\ddot{x}|=2 mGal.

In an embodiment, gravity survey data can be filtered with a low-pass filter with a selected time-window. The selection of the time window of the low-pass filter can depend on the objective of the gravity survey. In one example, time window selection is further illustrated with respect to the copper deposit exploration described below in Example 1.

In an embodiment, a particular filter can be selected to filter gravity survey data that is appropriate for the specific survey. For example, filter selection is further illustrated below with respect to maximum allowed positioning error for a certain choice of filter in FIG. 7.

Choice of the low-pass filter can be dependent on the positioning accuracy available. By way of example only, for a positioning accuracy up to 5 meters (e.g. GNSS), using Equation 11, the cutoff frequency of the low pass filter is 0.32 mHz or 3142 s to achieve 2 mGal gravimeter accuracy. In another example, for a positioning accuracy of up to 50 cm (e.g. Differential GNSS), using Equation 11, the cutoff frequency of the low pass filter is 1 mHz or 1000 s to achieve 2 mGal gravimeter accuracy. In another example, for a positioning accuracy of up to 1 cm (or better) (e.g. RTK-GNSS), with 0.5 cm, position accuracy, the cutoff frequency of the low pass filter is 10 mHz or 100 s to achieve 2 mGal gravimeter accuracy. To achieve 50 mGal accuracy, the cutoff frequency is 50 mHz or 20 s. Accordingly, a broad range of low-pass filter time windows can be defined, ranging between 20 s to 3200 s in certain embodiments. In other embodiments, other filters such as an RC filter or a Gaussian filter can be used instead of the low-pass filter.

While embodiments described herein for processing gravity survey data are focused on corrections due to the kinematic accelerations of the UAV, embodiments further considered can include several other corrections, as defined by Equation 12.

$$g = {g}_{meas} - {a}_{GNSS} + δ {g}_{Etvs} - δ {g}_{HAC} - δ {g}_{drift} + {g}_{link} \qquad ( Equation 12 )$$

where
gₘₑₐₛ: measured acceleration values from the gravimeter,
a_{GNSS}: kinematic acceleration of the UAV measured using GNSS positioning,
δg_{Etvs}: Eotvos effect corrections,
δg_{HAC}: horizontal acceleration correction,
δg_{drift}: corrections due to drift of the gravimeter, and
gₗᵢₙₖ: correction due to deviation from the reference gravity value at the base station. Note that Equation 12 is provided for illustration to depict certain exemplary corrections and is not intended to be an exhaustive list of corrections. For example, additional corrections such as latitude corrections, terrain corrections, etc. can also be incorporated.

Referring specifically to correction of kinematic acceleration of the UAV measured using GNSS positioning, the magnitude of error in gravity measurements introduced due to errors in determining aGNSS and the choice of frequency filter are dependent on the survey parameters. The amplitude of the gravity anomaly falls off as e^{-2πz/λ} where λ is the geologic wavelength of the anomaly. For simplicity, consider a gravity anomaly produced by a sphere buried in the ground and the survey is conducted by a UAV at a fixed height above the ground.

Referring to FIG. 8, a diagram of a gravity anomaly produced by a sphere of density contrast including a corresponding graph of geologic and Fourier wavelengths are depicted, according to an embodiment. In FIG. 8, a UAV having an onboard strapdown gravimeter 600 is depicted as flying along a terrain. A cross-sectional view of an underground area 602 includes a sphere of density contrast 604. The survey parameters can be defined as:
R: radius of the sphere,
z_{C}: vertical separation between the gravimeter and the center of the sphere,
z: vertical separation between the gravimeter and the top of the sphere,
v: horizontal velocity of the gravimeter, and
σ: mass density contrast.

The spherical mass density variation of σ produces a gravity anomaly that is detected by the gravity sensor as it passes over the sphere with velocity v. The gravitational anomaly produced by this sphere is provided by Equation 13.

$${g}_{z} = \frac{4 G π {R}^{3} σ}{3 {z}_{ε}^{2}} \cdot \frac{1}{{( 1 + \frac{{x}^{2}}{{z}_{c}^{2}} )}^{3 / 2}} \qquad ( Equation 13 )$$

For the sphere to be detected, it should produce a gravity anomaly larger than the gravimeter's inherent measurement noise, referred to as gₘₐₓ. Moreover, since the distance to the top of the sphere, z, is a more practical parameter than the distance to the center zC, Equation 13 can be rearranged to Equation 14.

$$σ = \frac{3 {g}_{max}}{4 G π} \cdot \frac{{( z + R )}^{2}}{{R}^{3}} \qquad ( Equation 14 )$$

As further depicted in FIG. 8, a graph of a geologic wavelength 700 and a Fourier wavelength 702 of a gravity anomaly produced by sphere of density contrast 604 is illustrated, according to an embodiment. The geologic wavelength 700, λ_{g}, produced by the anomaly is twice the half-width of the anomaly, w_{1/2}. Using Equation 13, a relation between the half width, the geologic wavelength 700 and the distance to the top of the sphere 604 can be derived as Equation 15.

$${λ}_{g} = 2 {w}_{1 / 2} = 1.54 ( z + R ) \qquad ( Equation 15 )$$

The Fourier wavelength 702, λ_{f}, is approximated as twice the geologic wavelength 700 in Equation 16.

$${λ}_{f} = 4 {w}_{1 / 2} = 3.1 ( z + R ) \qquad ( Equation 16 )$$

The Fourier wavelength 702 is used to detect the upper limit of the gravity signal waveband. Finally, the anomaly detection threshold frequency is calculated as Equation 17.

$${f}_{th} = \frac{v}{{λ}_{f}} \qquad ( Equation 17 )$$

### Example 1: Detecting Copper Ore

Embodiments of systems and methods can be practically applied to locate real-world physical anomalies. Assume a spherical copper ore deposit buried underneath the Earth's surface having a geometry as depicted in FIG. 8. The most commonly found ore is chalcopyrite (density ˜4,200 kgm⁻³), and it is usually found surrounded by volcanic rocks, or granite (density ˜2,700 kgm⁻³). Therefore, the copper ore deposit has a density contrast of σ=1,500 kgm⁻³. The minimum radius of the copper ore sphere that can be detected using a UAV survey conducted using embodiments of a strapdown gravimeter can be defined.

Assuming a gravity anomaly has to be 2× larger than the accuracy of the gravimeter, gₘₐₓ=2 mGal, and further assuming a UAV flight at 2 m height above the ground level, z=2+depth of the top of the sphere below the Earth's surface. Simulating three different values of z: 52 m, 152 m, and 502 m, the values for the radius of the smallest detectable sphere (producing gₘₐₓ=2 mGal), the Fourier wavelength, and the geologic wavelength produced are illustrated in Table 1. In particular, Table 1 depicts the smallest geologic features of a copper ore sphere (R, λ_{f} and λ_{g}) that can be detected with the UAV gravity survey, when the sphere is buried at various depths below the Earth's surface (z).

TABLE 1

| z [m] | R [m] | λ_{f} [m] | λ_{g} [m] |
|---|---|---|---|
| 52 | 106 | 490 | 245 |
| 152 | 171 | 1000 | 500 |
| 502 | 318 | 2541 | 1270 |

Accordingly, for a copper ore sphere buried 150 m below the earth's surface, the sphere would have to have a radius of at least 171 m, which will produce a gravity anomaly of geologic wavelength λ_{g}=500 m.

Referring further to FIG. 9, a graph of threshold detection frequencies compared to the horizontal speed of a UAV is depicted, according to an embodiment. In particular, FIG. 9 illustrates detection threshold frequency vs. horizontal velocity plots for spherical mineral ore deposits buried at various depths below the Earth's surface. As depicted in FIG. 9, depth z=52 m is depicted by line 800, depth z=152 m is depicted by line 802, and depth z=502 m is depicted by line 804. Using a 100 s filter, which implies a cut-off frequency of 0.01 Hz, a UAV can go as fast as 10 m/s, for the copper ore deposited at z=152 m to be detected in the survey.

### Example 2: Comparison with Aircraft-Borne Surveys

A comparison of the instant UAV gravity surveys with an aircraft-borne gravity survey is further illustrative of the advantages of embodiments of systems and methods described herein. In particular, a UAV gravity survey can be compared to an aircraft-borne gravity survey by assuming all other conditions remain the same. For purposes of illustration, the UAV and aircraft are carrying the same gravimeter and are surveying for copper (chalcopyrite) deposits surrounded by granite as in Example 1. The copper deposits are assumed to be of spherical shape at three depths: 400 m, 600 m, 800 m.

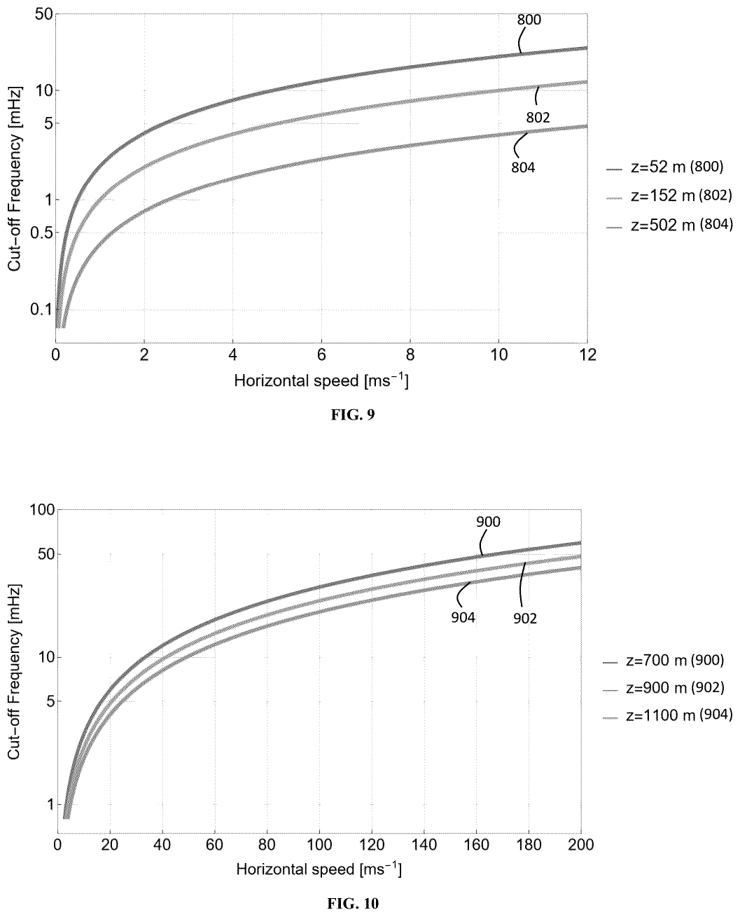

Assuming the aircraft is flying at a very low elevation above ground level of 300 m (which is generally impossible or impractical), and that aircraft cannot fly slower than ˜60 m/s, referring to FIG. 10, a graph of threshold detection frequencies compared to the horizontal speed of a non-UAV aircraft is depicted. In particular, FIG. 10 illustrates detection threshold frequency vs. horizontal velocity plots for spherical mineral ore deposits buried at various depths below the Earth's surface. As depicted in FIG. 10, depth z=700 m is depicted by line 900, depth z=900 m is depicted by line 902, and depth z=1100 m is depicted by line 904. With further reference to Table 2, the smallest geologic features of a copper ore sphere (R, λ_{f} and λ_{g}) that can be detected with the aircraft gravity survey are depicted, when the sphere is buried at various depths below the Earth's surface (z). Note that the ‘z’ value in Table 2 has +300 m added to it to account for the aircraft elevation above ground level.

TABLE 2

| z [m] | R [m] | λ_{f} [m] | λ_{g} [m] |
|---|---|---|---|
| 700 | 382 | 3355 | 1678 |
| 900 | 441 | 4157 | 2079 |
| 1100 | 495 | 4945 | 2473 |

Notably, to meet the threshold cutoff frequency of 0.01 Hz, the aircraft would have to go slower than 50 m/s, which is not feasible. Moreover, aircraft surveys can only detect very large geologic wavelengths (λ_{g}), indicating the need for the survey region to be very large. Finally, it is operationally challenging to conduct aircraft surveys with a tight grid spacing (<20 m), which is possible with the UAVs described herein.

Accordingly, gravity surveys conducted with a UAV having a strapdown gravity sensor offer several advantages over both ground-based surveys and aircraft-based surveys.

In one advantage, compared to fixed wing aircraft and helicopters, UAVs can fly at lower altitudes, and at much slower speeds. This enables obtaining data with higher spatial resolution, even while using the same gravity sensing device. In a further illustrative advantage, aircraft gravity surveys are limited to spatial resolution of ˜3,000 m. Gravity surveys conducted on a UAV with a strapdown gravity sensor can obtain ˜10 m spatial resolution, at a fraction of the development and operation cost of other types of gravity surveys.

In another advantage, the operation of an AGG requires a large aircraft with a specially trained crew. Comparatively, a UAV-borne gravimeter requires significantly lower development cost and time. Moreover, the operational cost for UAVs is much less than that of an aircraft/helicopter with a specially trained crew.

In another advantage, aircraft/helicopter-based surveys are typically only employed to survey large areas of land (˜100,000 sq. km.). Conducting smaller surveys with an aircraft/or helicopter leads to higher operational cost per unit area. Conversely, ground surveys are typically utilized for smaller survey areas (˜15,000 sq. km.). Conducting larger surveys leads to higher operational cost per unit area. UAVs therefore offer advantages over ground and aircraft/helicopter-based surveys.

1. A method of gravity prospecting with an unmanned aerial vehicle (UAV), comprising:
measuring total acceleration of a UAV during a gravity survey mission with a strapdown gravity sensor mounted to the UAV;
receiving a global navigation satellite system (GNSS) satellite signal at the UAV;
receiving a correction factor signal from a Real-time Kinematic (RTK)-GNSS base station at the UAV;
obtaining kinematic acceleration of the UAV using the GNSS satellite signal and the correction factor signal;
removing the kinematic acceleration of the UAV from the total acceleration of the UAV to obtain an effective gravitational acceleration;
performing frequency filtering on the effective gravitational acceleration by applying a low pass filter to determine a low-frequency region of the effective gravitational acceleration; and
determining a gravity anomaly based on the low-frequency region.

2. The method of claim 1, wherein the gravity anomaly is below a ground surface.

3. The method of claim 1, wherein the strapdown gravity sensor is a gravimeter mounted in a body frame (b-frame) of the UAV, and wherein the gravimeter changes orientation with the UAV.

4. The method of claim 3, wherein the measuring total acceleration includes transforming acceleration measured in the b-frame to acceleration in a navigation frame (n-frame).

5. The method of claim 1, wherein the GNSS satellite signal triggers the strapdown gravity sensor to measure the total acceleration.

6. The method of claim 1, wherein removing the kinematic acceleration of the UAV from the total acceleration of the UAV comprises subtracting the kinematic acceleration from the total acceleration.

7. The method of claim 1, wherein the GNSS satellite signal has a GNSS positional accuracy of equal to or less than 3 cm.

8. The method of claim 1, wherein the GNSS satellite signal is GNSS-derived kinematic location and the correction factor signal include a correction factor,
wherein the GNSS-derived kinematic location is corrected by the correction factor, and
wherein the kinematic acceleration is obtained by double differentiating the GNSS-derived kinematic location corrected by the correction factor.

9. The method of claim 1, wherein the gravity survey mission is conducted by flying the UAV at a constant elevation between 0.05 m and 80 m above a ground surface.

10. The method of claim 1, wherein the gravity survey mission is conducted by flying the UAV at a speed between 0 m/s and 60 m/s.

11. A system for gravity prospecting, comprising:
an unmanned aerial vehicle (UAV) including:
a processor and a memory operably coupled to the processor,
a strapdown gravity sensor configured to measure total acceleration of the UAV during a gravity survey mission, and
a GNSS transceiver configured to receive a global navigation satellite system (GNSS) satellite signal and a correction factor signal and determine a kinematic acceleration of the UAV using the GNSS satellite signal and the correction factor signal; and
a gravity data processing engine configured to:
remove the kinematic acceleration of the UAV from the total acceleration of the UAV to obtain an effective gravitational acceleration,
perform frequency filtering on the effective gravitational acceleration by applying a low pass filter to determine a low-frequency region of the effective gravitational acceleration, and
determine a gravity anomaly based on the low-frequency region.

12. The system of claim 11, wherein the strapdown gravity sensor is a gravimeter mounted in a body frame of the UAV, and wherein the gravimeter changes orientation with the UAV.

13. The system of claim 11, wherein the gravity data processing engine is located on at least one of the UAV or a ground base station.

14. The system of claim 11, further comprising:
a GNSS satellite communicatively coupled to the GNSS transceiver and configured to transmit the GNSS satellite signal; and
a Real-time Kinematic (RTK)-GNSS base station communicatively coupled to the GNSS satellite and configured to transmit the correction factor signal.

15. The system of claim 11, wherein the strapdown gravity sensor is not mounted on a stabilization platform.

16. The system of claim 11, wherein the strapdown gravity sensor uses the GNSS satellite signal to measure the total acceleration.

17. The system of claim 11, wherein the UAV further comprises a UAV guidance engine configured to fly the UAV at a constant elevation between 0.05 m and 80 m above a ground surface during a gravity survey mission.

18. The system of claim 11, wherein the UAV further comprises a UAV guidance engine configured to fly the UAV at a speed between 0 m/s and 60 m/s during a gravity survey mission.

19. A method of gravity prospecting with an unmanned aerial vehicle (UAV), comprising:
measuring kinematic acceleration of the UAV using a global navigation satellite system (GNSS) satellite signal and a Real-time Kinematic (RTK)-GNSS base station correction factor signal;
measuring gravitational acceleration in a body frame (b-frame) of the UAV with a gravity sensor;
associating the kinematic acceleration with the gravitational acceleration; and
isolating a gravity anomaly signal in the gravitational acceleration using the kinematic acceleration.

20. The method of claim 19, wherein associating the kinematic acceleration with the gravitational acceleration comprises triggering the gravity sensor to measure the gravitational acceleration with the GNSS satellite signal.
